(19) United States
(12) Patent Application Publication
(10) Pub. No.: US 2016/0377700 A1
(43) Pub. Date: Dec. 29, 2016

(54) DOPPLER GEOLOCATION SYSTEM (DGS)

(71) Applicant: GOVERNMENT OF THE UNITED STATES OF AMERICA, AS REPRESENTED BY THE SECRETARY OF THE NAVY, Arlington, VA (US)

(72) Inventors: CHRISTOPH R. ENGLERT, Springfield, VA (US); Andrew C. Nicholas, Glenelg, MD (US)

(73) Assignees: Christoph R. Englert, Springfield, VA (US); Andrew C. Nicholas, Glenelg, MD (US)

(21) Appl. No.: 15/190,292

(22) Filed: Jun. 23, 2016

Related U.S. Application Data
(60) Provisional application No. 62/184,598, filed on Jun. 25, 2015.

(51) Int. Cl. G01S 5/10

(52) U.S. Cl. CPC G01S 5/10

(57) ABSTRACT

In a geolocation method and/or apparatus, a plurality of satellites is provided in a fixed Earth-Sun coordinate system or a fixed Earth-moon coordinate system. Two respective radio frequency band signals of the plurality of respective radio frequency band signals are received by at least one receiver from at least two satellites of the plurality of satellites, the at least one receiver comprising at least one respective geolocation. The at least one receiver generating at least two pluralities of equal Doppler shift contours corresponding to the at least two satellites of the plurality of satellites. The at least one receiver determines the at least one respective geolocation based at least in part on a universal time and intersections of the at least two pluralities of equal Doppler shift contours. The at least one receiver outputs the at least one respective geolocation.

### CROSS-REFERENCE TO RELATED APPLICATIONS

The present application claims priority to U.S. Provisional Patent Application Ser. No. 62/184,598, which was filed on 25 Jun. 2015.

### FIELD OF THE INVENTION

This invention relates in general to an apparatus and method for geolocation, and in particular to an apparatus and method for geolocation using Doppler shift analysis.

### DESCRIPTION OF THE RELATED ART

Many geolocation systems use and/or depend on the currently existing Global Positioning System (“GPS”), for example, as discussed in U.S. Pat. No. 3,199,229 to Easton and U.S. Pat. No. 3,789,409 to Easton, both incorporated herein by reference. GPS is a constellation of around 32 satellites orbiting Earth, all in a medium Earth orbit (“MEO”), i.e., at an altitude of around 20,000 km. (Twenty-four GPS satellites are required to provide complete Earth coverage, the remaining satellites being spares). At any location on Earth and at any time, at least four GPS satellites are visible. Each satellite of the at least four GPS satellites has its own atomic clock. Each satellite of the at least four GPS satellites transmits positional information and the time the positional information is sent at regular intervals. Signals from at least three of the visible satellites are intercepted by a user's GPS receiver, which calculates how far away each satellite is based on how long it took for the signal to arrive at the GPS receiver. Based on how far away the at least three visible satellites are, the GPS receiver geolocates itself in three-dimensional space using standard trilateration. The addition of signal information from the fourth GPS receiver optionally provides an altitude for the geolocation of the GPS receiver.

A concern of GPS users is that if GPS is rendered inoperable or if it is spoofed, there is no comparable, independent U.S. system that can provide similar geolocation information. Resilient position knowledge is important for many systems, including, for example, the open ocean environment, where alternative positioning techniques are limited.

### BRIEF SUMMARY OF THE INVENTION

One or more embodiments of the invention address a concern of GPS users that, if GPS is rendered inoperable or if it is spoofed, there is no comparable, independent U.S. system capable of providing similar geolocation information.

One or more embodiments of the invention provide resilient position knowledge important for many systems including, for example, one operating in the open ocean environment, where alternative positioning techniques are limited.

One or more embodiments of the invention provides a quick, robust geopositioning solution that is largely independent of tropospheric weather conditions, when compared to alternative GPS solutions such as optical measurements of celestial objects (e.g., measurements using a sextant).

### BRIEF DESCRIPTION OF THE DRAWINGS

FIG. 1 is an illustrative embodiment of the invention in a fixed Earth-Sun coordinate system.

FIG. 2 is an illustrative map of the Earth showing two illustrative locations of a receiver according to an embodiment of the instant invention.

FIG. 3 is an illustrative map of the Earth showing illustrative equal Doppler shift contours for respective satellites according to an embodiment of the invention.

FIG. 4 is an illustrative embodiment of the invention in a fixed Earth-moon coordinate system.

### DETAILED DESCRIPTION OF THE INVENTION

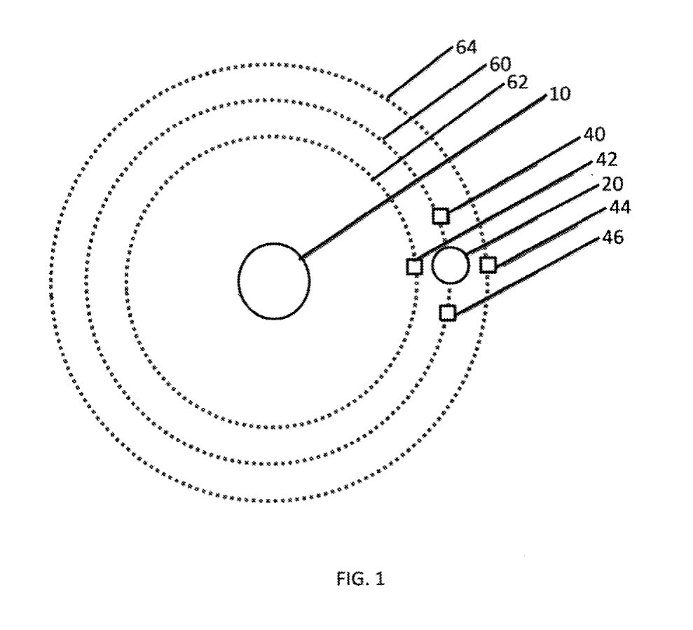

An embodiment of the invention includes a Doppler Geolocation System (“DGS”) embodiment, as shown by way of illustration in FIG. 1. This DGS embodiment includes a plurality of standard satellites 40, 42, 44, 46 in a fixed Earth-Sun coordinate system. Examples of the standard satellites include standard RF broadcasting satellites, such as standard navigation satellites. The fixed Earth-Sun coordinate system includes the plurality of satellites 40, 42, 44, 46 orbiting the Sun 10 in an ecliptic, at constant (or, equivalently, stationary) positions with respect to the coordinate system in which the Sun 10 and the Earth 20 are stationary. The plurality of satellites includes an inner satellite 42 in inner heliocentric orbit 62 closer to the Sun than the Earth's heliocentric orbit 60. The plurality of satellites includes an outer satellite 44 in outer heliocentric orbit 64 further away from the Sun than the Earth's heliocentric orbit. The plurality of satellites includes a leading satellite 40 ahead in the Earth's heliocentric orbit 60 but ahead of the Earth 20. The plurality of satellites includes a trailing satellite 46 in the Earth's heliocentric orbit 60 but behind the Earth 20. The plurality of satellites transmits a plurality of respective radio frequency signals. For the purpose of this patent application, the terms “constant” or “stationary” satellites indicate that each satellite is at a location in space and time predictable in a standard manner within the Earth-Sun coordinate system.

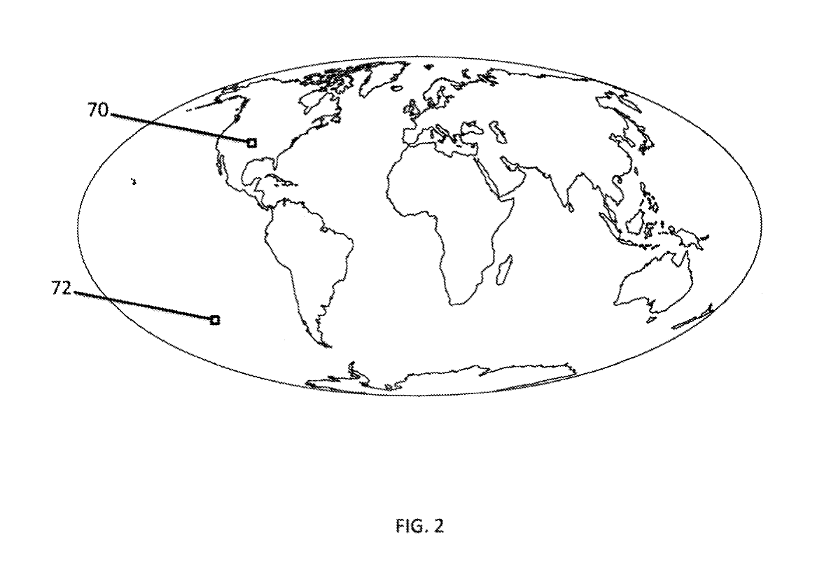

As shown by way of illustration in FIG. 2, this DGS embodiment further includes at least one standard radio frequency band receiver 70, 72 on the Earth receiving two respective radio frequency signals (e.g., Ultra High Frequency 300 MHz-3 GHz) of the plurality of respective radio frequency signals from at least two satellites 40, 44; 44, 46; 46, 42; 42, 40 of the plurality of satellites. For example, the at least one receiver is on land, as shown, by way of example, with respect to receiver 70. For example, the at least one receiver is on a body of water, as shown, by way of example, with respect to receiver 72. The at least one receiver 70, 72 includes at least one respective geolocation. The at least one receiver 70, 72 outputs the at least one respective geolocation based in part on a universal time and the two respective radio frequency band signals.

Optionally, the leading satellite 40, the Earth 20, and the trailing satellite 46 are substantially located in or along a first line. The Sun, the inner satellite, the Earth, and the outer satellite are substantially located in or along a second line. One of ordinary skill in the art will readily appreciate that the term “line” here is not used in the geometric sense of having a width of a point, i.e., infinitely thin. For the purposes of this patent application, the phrase “substantially located in or along a line” used herein is intended to include satellite positions viewed from the Earth of up to 45° off a line connecting the Earth and the Sun in an Earth-Sun coordinate system or of up to 45° off a line connecting the Moon and the Earth in an Earth-Moon coordinate system. One of ordinary skill in the art will readily appreciate that the greater the angle a satellite is off a line, then either the greater the lack of geolocation coverage of the Earth or the greater the need for at least one additional satellite to provide for the otherwise lost geolocation coverage. For the purposes of this patent application, the phrase “along a line” used herein includes placing a satellite at a location within the constraints of orbital mechanics and station-keeping capabilities, including halo orbits around Lagrangian points. The first line is substantially perpendicular to the second line, whereby having the satellites located along perpendicular lines maximizes the coverage with four satellites of the Earth. One of ordinary skill in the art will readily appreciate that FIG. 1 is not drawn to scale.

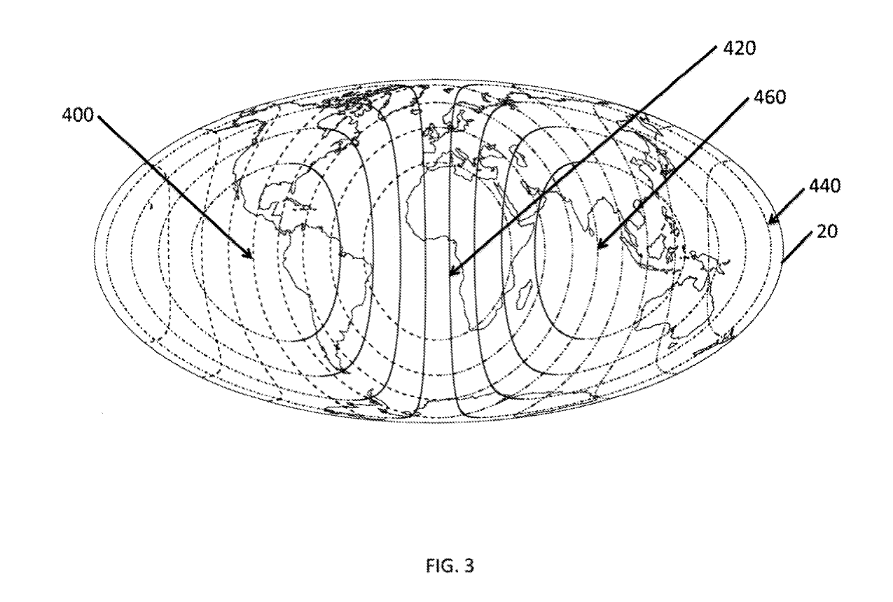

Optionally, as shown by way of illustration in FIG. 3, the at least one receiver 70, 72 generates two pluralities of equal Doppler shift contours corresponding to the two respective radio frequency band signals. The at least one receiver determines at least one respective intersection of two equal Doppler shift contours of the two pluralities of equal Doppler shift contours. The at least one respective geolocation is based in part on this intersection. Illustrative equal Doppler shift contours are shown, by way of example, in FIG. 2. For example, illustrative equal Doppler shift contours 400 (indicated by dashed contours) correspond to those generated by satellite 40. For example, illustrative equal Doppler shift contours 420 (indicated by solid contours) correspond to those generated by satellite 42. For example, illustrative equal Doppler shift contours 440 (indicated by dot dash contours) correspond to those generated by outer satellite 44. For example, illustrative equal Doppler shift contours 460 (indicated by dot dot dot dash contours) correspond to those generated by trailing satellite 46. Where the equal Doppler shift contours meet, the Doppler shifts have the same absolute value, but opposite signs because the receiver's location is moving toward one satellite (e.g. satellite 42) and is moving away from a neighboring satellite (e.g. satellite 44).

As an example, if receiver 70 receives radio frequency signals from leading satellite 40 and outer satellite 44 and generates equal Doppler shift contours based on the received radio frequency signals. The intersection of the equal Doppler shift contours corresponding to leading satellite 40 and outer satellite 44 would result in two possible geolocation solutions: one in the northern hemisphere (in this example, a specific location in the United States) and one in the southern hemisphere (in this example, a specific location in the Pacific Ocean). Only one geolocation solution will make sense to a DGS user, given a known time for the receiver to determine the phase of the rotation of the Earth with respect to the satellites. A ship-based DGS user with receiver 72 would reject the northern hemispheric, land geolocation, and a land-based DGS user with receiver 70 would reject the southern hemispheric, ocean geolocation.

Optionally, the at least one receiver 70, 72 converts in a standard manner the universal time to at a respective satellite longitude and a respective satellite latitude for each of the at least two satellites 40, 44. For example, the at least one receiver includes a standard software program (e.g., Analytical Graphics Inc.'s Systems Tool Kit) for calculating the Earth's rotation and tilt as a function of time for a given time. The at least one receiver, for example, includes a standard clock. The standard clock includes for example, a standard quartz clock, a standard oven controlled crystal oscillator (“OCXO”), or a standard atomic clock. A quartz clock can achieve accuracy up to approximately a second per month. An OCXO can achieve accuracy of about half of a second per year. An atomic clock can achieve accuracies orders of magnitude higher than that of the OCXO. One of ordinary skill in the art will readily appreciate that greater time accuracy at the receiver corresponds to greater geolocation accuracy. Twenty-four hours correspond to 360° in longitude. Thus, one second is equivalent to 4.17e-3°. At the equator (i.e., in the worst case scenario), a one second discrepancy corresponds to a geolocation error of about 464 meters or about a quarter of a mile.

Optionally, the universal time comprises one of Greenwich Mean Time, UTC universal time, UTC0 universal time, UT1 universal time, UT1R universal time, UTC2 universal time, international atomic time, and barycentric dynamical time. Optionally, the universal time comprises a year and a day of the year. Optionally, the universal time further includes hours, minutes and seconds. For example, the universal time includes a format such as YYYY DDD HH:MM:SS.

Optionally, each satellite of the plurality of satellites 40, 42, 44, 46 comprises about 180° of latitude and longitude coverage of the Earth. One of ordinary skill in the art will readily appreciate that less coverage by satellites in the plurality of satellites is consistent with invention. Such a coverage limitation simply means that either more satellites are required in the plurality of satellites to obtain Earth-wide geolocation coverage, or that a loss of geolocation coverage for small amounts of time are acceptable to a DGS user until two satellites come into view of the DGS user's receiver.

Another apparatus embodiment of the invention is described as follows, again with reference to, by way of illustration, FIG. 1. This DGS embodiment includes the placement of a minimum of four standard RF broadcasting satellites 40, 42, 44, 46 in a standard fixed Earth-Sun coordinate system. An example of such a standard RF broadcasting satellite is a standard navigation satellite. That is, the four or more satellites 40, 42, 44, 46 are in orbit around the Sun 10 so that their relative position with respect to Earth 20 is not changing. The standard satellites 40, 42, 44, 46 include standard RF transmitters for transmitting standard radio frequency (e.g., Ultra High Frequency 300 MHz-3 GHz) signals. A signal from each satellite includes a UTC, which is used to infer a rotation of the Earth 20 with respect to the Sun-Earth line, and thus the exact position in terms of longitude and latitude over which the satellite is located. Optionally, the signal from the satellite further includes exact position in terms of longitude and latitude over which the satellite is located. Such exact satellite-position information relaxes the station-keeping requirements at the expense of increased satellite and receiver complexity.

Station keeping of these satellites is achieved, for example, utilizing standard solar sails, standard reactive engines (such as standard ion propulsion engines or standard liquid propellant rockets), or other standard forms of propulsion. For example, minimizing station-keeping effort involves placement of two (of the four or more) satellites in the same orbit as the Earth, but one trailing and one leading the Earth in its orbit. Two additional (of the four or more) satellites are positioned along a Sun-Earth line so that from nearly every point on Earth at least two satellites are in direct line of sight.

Each satellite of an embodiment of the invention emits a single, unique, stable, known electromagnetic frequency (e.g., in the GHz range). Doppler shift measurements of the signals from the two satellites within direct line of sight from a location on the Earth, from aircraft or other satellites, constrain the position to lines of equal Doppler shift. These lines of equal Doppler shift are shown, by way of illustration in FIG. 3, where the contour dashes correspond to the DGS satellites discussed above. The range of Doppler shifts (or velocities) for a location on Earth is equivalent to 0 m/s to 464 m/s (0<v/c<1.55×10⁻⁶ or 0 kHz<Δf<2.3 kHz at f=1.5 GHz). An absolute Doppler shift observation is made by a standard radio frequency band receiver on Earth.

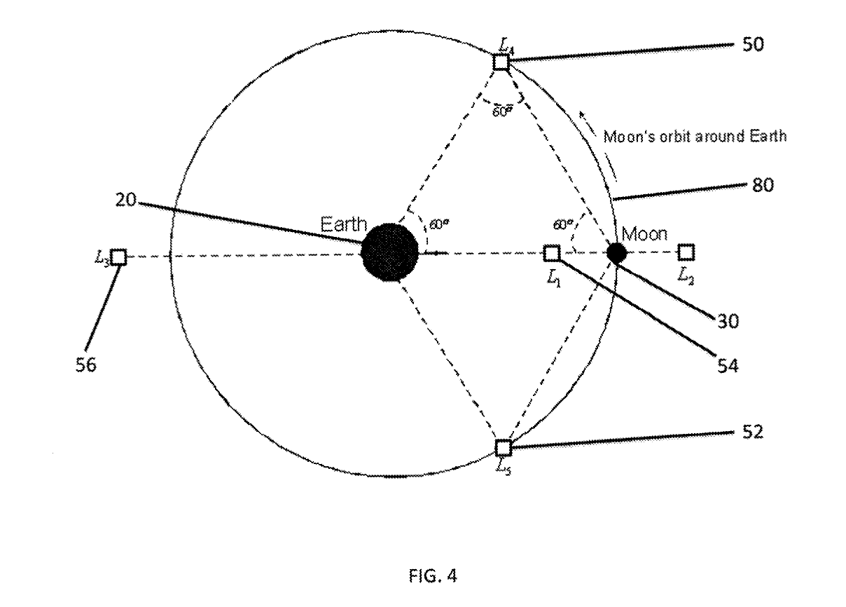

As shown by way of illustration in FIG. 4, another DGS embodiment includes a plurality of satellites 60, 62, 64, 66 in a fixed Earth-moon coordinate system including the plurality of satellites orbiting an Earth in a lunar orbital plane at constant positions with respect to the fixed Earth-moon coordinate system in which the plurality of satellites are stationary relative to the Earth and the Earth's moon. The plurality of satellites includes an inner satellite 54 in a first Earth-centric orbit closer to the Earth than a lunar orbit 80. Optionally, at an extreme, the inner satellite 54 is located on the moon facing the Earth, and therefore is in the lunar orbit. The plurality of satellites includes at least one leading satellite 50 ahead in the lunar orbit but ahead of the moon. The plurality of satellites includes at least one trailing satellite 52 in the lunar orbit but behind the moon. The plurality of satellites transmits a plurality of respective radio frequency signals. The apparatus further includes at least one receiver receiving two respective radio frequency signals of the plurality of respective radio frequency signals from at least two satellites of the plurality of satellites. The at least one receiver includes at least one respective geolocation. The at least one receiver outputs the at least one respective geolocation based in part on a universal time and the two respective radio frequency band signals. For the purpose of this patent application, the above mention of “stationary” satellites indicates that each satellite is at a location in space and time predictable in a standard manner relative to the Sun-Earth coordinate system, as discussed above.

Optionally, the leading satellite 50, the Earth, and the trailing satellite 52 are substantially located in a first line. The inner satellite 54, the Earth, and another leading satellite 56 are substantially located in a second line. The first line is substantially perpendicular to the second line.

Optionally, the at least one receiver 70, 72 generates two pluralities of equal Doppler shift contours 400, 440 corresponding to the two respective radio frequency band signals. The at least one receiver 70, 72 determines at least one respective intersection of two equal Doppler shift contours of the two pluralities of equal Doppler shift contours. The at least one respective geolocation is based in part on the intersection.

Optionally, the at least one receiver 70, 72 converts the universal time to at a respective satellite longitude and a respective satellite latitude for each of the at least two satellites, for example, satellite 50 and satellite 54; satellite 54 and satellite 52; satellite 52 and satellite 56; and satellite 56 and satellite 50. For example, the at least one receiver includes a standard clock. The standard clock includes for example, a standard quartz clock, a standard oven controlled crystal oscillator (“OCXO”), or a standard atomic clock. For example, the at least one receiver includes a standard software program (e.g., Analytical Graphics Inc.'s Systems Tool Kit) for calculating the Earth's rotation and tilt as a function of time for a given time.

Optionally, the universal time comprises one of Greenwich Mean Time, UTC universal time, UTC0 universal time, UT1 universal time, UT1R universal time, UTC2 universal time, international atomic time, and barycentric dynamical time. Optionally, the universal time comprises a year and a day of the year.

Optionally, the satellite 66, the inner satellite 54, at least one leading satellite 50, and/or at least one trailing satellite 52 are located at an Earth-Moon Lagrange point. As mentioned above, the inner satellite 54 is optionally on the moon facing the Earth. At the Lagrange points, the gravity from the Earth, the gravity from the moon and the dynamic forces are balanced and station keeping requires less energy.

As a practical matter, one of ordinary skill in the art will readily appreciate that a DGS system including four satellites 50, 52, 54, 56 located at Lagrange positions L1, L3, L4, and L5 would suffer from lack of geolocation coverage of the Earth because at times two satellites would not be visible simultaneously to a DGS user with a receiver on the Earth. In blue water applications, such lack of coverage may be acceptable. Alternatively, one or more additional satellites are included in an alternative DGS embodiment and spaced such that each satellite in the DGS constellation of satellites covers up to 90° of the Earth. Alternatively, satellite 50 at the IA Lagrange location and/or satellite 52 at the L5 Lagrange location in an alternative DGS embodiment are located further apart and closer to satellite 56 at the L3 Lagrange point to provide more or full geolocation coverage of the Earth. Such an alternative DGS embodiment necessarily entails greater station keeping effort by satellites 50 and 52 for station keeping.

Optionally, each satellite of the plurality of satellites comprises about 180° of latitude and longitude coverage of the Earth.

An embodiment of the invention includes a method of geolocation and will be described with reference to FIGS. 1-4. A plurality of satellites is provided in a fixed Earth-Sun coordinate system or a fixed Earth-moon coordinate system. The plurality of satellites 40, 42, 44, 46 in the fixed Earth-Sun coordinate system includes the plurality of satellites orbiting a Sun in the ecliptic at constant positions with respect to the fixed Earth-Sun coordinate system in which an Earth and the Sun are stationary relative to the plurality of satellites. The plurality of satellites 50, 52, 54, 56 in the fixed Earth-moon coordinate system comprising the plurality of satellites orbiting the Earth in a lunar orbital plane at constant positions with respect to the fixed Earth-moon coordinate system in which the Earth and a moon are stationary relative to the plurality of satellites. Two respective radio frequency band signals of the plurality of respective radio frequency band signals are received by at least one receiver 70, 72 from at least two satellites of the plurality of satellites, the at least one receiver comprising at least one respective geolocation. The at least one receiver generating at least two pluralities of equal Doppler shift contours 400, 440 corresponding to the at least two satellites of the plurality of satellites 40, 44; 44, 46; 46, 42; 42, 40. The at least one receiver 70, 72 determines the at least one respective geolocation based at least in part on a universal time and intersections of the at least two pluralities of equal Doppler shift contours 400, 440. The at least one respective geolocation is outputted on the at least one receiver 70, 72.

Optionally, the plurality of satellites in the fixed Earth-Sun coordinate system includes the plurality of satellites including an inner satellite in heliocentric orbit closer to the Sun than the Earth's heliocentric orbit. The plurality of satellites includes an outer satellite in heliocentric orbit further away from the Sun than the Earth's heliocentric orbit, the plurality of satellites comprising a leading satellite ahead in the Earth's heliocentric orbit but ahead of the Earth. The plurality of satellites includes a trailing satellite in the Earth's heliocentric orbit but behind the Earth. The plurality of satellites transmits a plurality of respective radio frequency signals.

Optionally, the plurality of satellites in the fixed Earth-moon coordinate system includes the plurality of satellites including an inner satellite in a first Earth-centric orbit closer to the Earth than a lunar orbit. The plurality of satellites includes at least one leading satellite ahead in the lunar orbit but ahead of the moon. The plurality of satellites includes at least one trailing satellite in the lunar orbit but behind the moon. The plurality of satellites transmits a plurality of respective radio frequency signals.

Optionally, this method embodiment further includes the following steps. A user input is received and/or a prior known geolocation is retrieved (e.g., from a standard memory in the receiver) at the at least one receiver. The user input and/or the prior known geolocation includes a northern hemispheric indication or a southern hemispheric indication. Determining the at least one respective geolocation at the at least one receiver based at least in part on the universal time and intersections of the at least two pluralities of equal Doppler shift contours 400, 440 further includes determining the at least one respective geolocation at the at least one receiver based at least in part on the one of the user input and the prior known geolocation.

Optionally, determining the at least one respective geolocation at the at least one receiver includes determining a respective Earth longitude and a respective Earth latitude over which a corresponding satellite of the at least two satellites is located. Optionally, based on a known time, the receiver determines the phase of the rotation of the Earth with respect to the satellites.

Advantageously, in one or more embodiments of the invention, orbits of the satellites can be in different altitude ranges than the current GPS constellation so that any disruption in MEO would not apply to the satellites in an embodiment of the instant invention.

Advantageously, in one or more embodiments of the invention, the only information necessary to determine a position are two absolute Doppler shift measurements, UTC, and the hemisphere (north or south) in which the receiver site is located.

Portions of the invention described above operate in a standard computing operating environment, for example, a desktop computer, a laptop computer, a mobile computer, a server computer, and the like, in which embodiments of the invention may be practiced. While portions of the invention are described in the general context of program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, autonomous embedded computers, and the like. The invention may also be practiced in distributed computing environments where tasks are performed by remote processing devices that are linked through a communications network. In a distributed computing environment, program modules may be located in both local and remote memory storage devices.

An illustrative operating environment for embodiments of the invention will be described. A computer comprises a general purpose desktop, laptop, handheld, mobile or other type of computer (computing device) capable of executing one or more application programs. The computer includes at least one central processing unit (“CPU”), a system memory, including a random access memory (“RAM”) and a read-only memory (“ROM”), and a system bus that couples the memory to the CPU. A basic input/output system containing the basic routines that help to transfer information between elements within the computer, such as during startup, is stored in the ROM. The computer further includes a mass storage device for storing an operating system, application programs, and other program modules.

The mass storage device is connected to the CPU through a mass storage controller (not shown) connected to the bus. The mass storage device and its associated computer-readable media provide non-volatile storage for the computer. Although the description of computer-readable media contained herein refers to a mass storage device, such as a hard disk or CD-ROM drive, it should be appreciated by those skilled in the art that computer-readable media can be any available media that can be accessed or utilized by the computer.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other tangible non-transitory medium which can be used to store the desired information and which can be accessed by the computer.

According to various embodiments of the invention, the computer may operate in a networked environment using logical connections to remote computers through a network, such as a local network, the Internet, etc. for example. The computer may connect to the network through a network interface unit connected to the bus. It should be appreciated that the network interface unit may also be utilized to connect to other types of networks and remote computing systems.

The computer may also include an input/output controller for receiving and processing input from a number of other devices, including a keyboard, mouse, etc. Similarly, an input/output controller may provide output to a display screen, a printer, or other type of output device.

As mentioned briefly above, a number of program modules and data files may be stored in the mass storage device and RAM of the computer, including an operating system suitable for controlling the operation of a networked personal computer. The mass storage device and RAM may also store one or more program modules. In particular, the mass storage device and the RAM may store application programs, such as a software application, for example, a word processing application, a spreadsheet application, a slide presentation application, a database application, etc.

It should be appreciated that various embodiments of the present invention may be implemented as a sequence of computer-implemented acts or program modules running on a computing system and/or as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as described herein.

Although a particular feature of the disclosure may have been illustrated and/or described with respect to only one of several implementations, such feature may be combined with one or more other features of the other implementations as may be desired and advantageous for any given or particular application. Also, to the extent that the terms “including”. “includes”, “having”, “has”, “with”, or variants thereof are used in the detailed description and/or in the claims, such terms are intended to be inclusive in a manner similar to the term “comprising”.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. An apparatus comprising:
a plurality of satellites in a fixed Earth-Sun coordinate system comprising said plurality of satellites orbiting a Sun in an ecliptic, at constant positions with respect to the fixed Earth-Sun coordinate system in which the Sun and Earth are stationary, said plurality of satellites comprising an inner satellite in solar orbit closer to the Sun than the Earth's heliocentric orbit, said plurality of satellites comprising an outer satellite in heliocentric orbit further away from the Sun than the Earth's heliocentric orbit, said plurality of satellites comprising an leading satellite ahead in the Earth's heliocentric orbit but ahead of the Earth, said plurality of satellites comprising a trailing satellite in the Earth's heliocentric orbit but behind the Earth, said plurality of satellites transmitting a plurality of respective radio frequency signals; and
at least one receiver receiving two respective radio frequency signals of the plurality of respective radio frequency signals from at least two satellites of the plurality of satellites, said at least one receiver comprising at least one respective geolocation, said at least one receiver outputting said at least one respective geolocation based in part on a universal time and said two respective radio frequency band signals.

2. The apparatus according to claim 1, wherein said leading satellite, the Earth, and said trailing satellite are substantially located in a first line, the Sun, said inner satellite, the Earth, and said outer satellite being substantially located in a second line, the first line being substantially perpendicular to the second line.

3. The apparatus according to claim 1, wherein said at least one receiver generates two pluralities of equal Doppler shift contours corresponding to said two respective radio frequency band signals, said at least one receiver determining at least one respective intersection of two equal Doppler shift contours of said two pluralities of equal Doppler shift contours, said at least one respective geolocation being based in part on the intersection.

4. The apparatus according to claim 1, wherein said at least one receiver converting the universal time to at a respective satellite longitude and a respective satellite latitude for each of the at least two satellites.

5. The apparatus according to claim 1, wherein the universal time comprises one of Greenwich Mean Time, UTC universal time, UTC0 universal time, UT1 universal time, UT1 R universal time, UTC2 universal time, international atomic time, and barycentric dynamical time.

6. The apparatus according to claim 5, wherein the universal time comprises a year and a day of the year.

7. The apparatus according to claim 1, wherein each satellite of the plurality of satellites comprises about 180° of latitude and longitude coverage of the Earth.

8. A method comprising:
providing a plurality of satellites in one of a fixed Earth-Sun coordinate system and a fixed Earth-moon coordinate system, the plurality of satellites in the fixed Earth-Sun coordinate system comprising the plurality of satellites orbiting a Sun in the ecliptic at constant positions with respect to the fixed Earth-Sun coordinate system in which an Earth and the Sun are stationary relative to the plurality of satellites, the plurality of satellites in the fixed Earth-moon coordinate system comprising the plurality of satellites orbiting the Earth in a lunar orbital plane at constant positions with respect to the fixed Earth-moon coordinate system in which the Earth and a moon are stationary relative to the plurality of satellites;
receiving two respective radio frequency band signals of the plurality of respective radio frequency band signals by at least one receiver from at least two satellites of the plurality of satellites, the at least one receiver comprising at least one respective geolocation;
generating at the at least one receiver at least two pluralities of equal Doppler shift contours corresponding to the at least two satellites of the plurality of satellites;
determining the at least one respective geolocation at the at least one receiver based at least in part on a universal time and intersections of the at least two pluralities of equal Doppler shift contours; and
outputting the at least one respective geolocation on the at least one receiver.

9. The method according to claim 8, wherein the plurality of satellites in the fixed Earth-Sun coordinate system comprises the plurality of satellites comprising an inner satellite in heliocentric orbit closer to the Sun than the Earth's heliocentric orbit, the plurality of satellites comprising an outer satellite in heliocentric orbit further away from the Sun than the Earth's heliocentric orbit, the plurality of satellites comprising an leading satellite ahead in the Earth's heliocentric orbit but ahead of the Earth, the plurality of satellites comprising a trailing satellite in the Earth's heliocentric orbit but behind the Earth, the plurality of satellites transmitting a plurality of respective radio frequency signals.

10. The method according to claim 8, wherein the plurality of satellites in the fixed Earth-moon coordinate system comprises the plurality of satellites comprising an inner satellite in a first Earth-centric orbit closer to the Earth than a lunar orbit, the plurality of satellites comprising at least one leading satellite ahead in the lunar orbit but ahead of the moon, the plurality of satellites comprising at least one trailing satellite in the lunar orbit but behind the moon, the plurality of satellites transmitting a plurality of respective radio frequency signals.

11. The method according to claim 8, further comprising:
one of receiving a user input and retrieving a prior known geolocation at the at least one receiver, the user input and the prior known geolocation comprising one of a northern hemispheric indication and a southern hemispheric indication,
wherein said determining the at least one respective geolocation at the at least one receiver based at least in part on the universal time and intersections of the at least two pluralities of equal Doppler shift contours further comprises determining the at least one respective geolocation at the at least one receiver based at least in part on the one of the user input and the prior known geolocation.

12. The method according to claim 8, wherein said determining the at least one respective geolocation at the at least one receiver comprising determining a respective Earth longitude and a respective Earth latitude over which a corresponding satellite of the at least two satellites is located.

13. An apparatus comprising:
a plurality of satellites in a fixed Earth-moon coordinate system comprising said plurality of satellites orbiting an Earth in a lunar orbital plane at constant positions with respect to the fixed Earth-moon coordinate system in which the Earth and a moon are stationary relative to said plurality of satellites, said plurality of satellites comprising an inner satellite in a first Earth-centric orbit closer to the Earth than a lunar orbit, said plurality of satellites comprising at least one leading satellite ahead in the lunar orbit but ahead of the moon, said plurality of satellites comprising at least one trailing satellite in the lunar orbit but behind the moon, said plurality of satellites transmitting a plurality of respective radio frequency signals; and
at least one receiver receiving two respective radio frequency signals of the plurality of respective radio frequency signals from at least two satellites of the plurality of satellites, said at least one receiver comprising at least one respective geolocation, said at least one receiver outputting said at least one respective geolocation based in part on a universal time and said two respective radio frequency band signals.

14. The apparatus according to claim 13, wherein said leading satellite, the Earth, and said trailing satellite are substantially located in a first line, said inner satellite, the Earth, and another leading satellite being substantially located in a second line, the first line being substantially perpendicular to the second line.

15. The apparatus according to claim 13, wherein said at least one receiver generates two pluralities of equal Doppler shift contours corresponding to said two respective radio frequency band signals, said at least one receiver determining at least one respective intersection of two equal Doppler shift contours of said two pluralities of equal Doppler shift contours, said at least one respective geolocation being based in part on the intersection.

16. The apparatus according to claim 13, wherein said at least one receiver converting the universal time to at a respective satellite longitude and a respective satellite latitude for each of the at least two satellites.

17. The apparatus according to claim 13, wherein the universal time comprises one of Greenwich Mean Time, UTC universal time, UTC0 universal time, UT1 universal time, UT1R universal time, UTC2 universal time, international atomic time, and barycentric dynamical time.

18. The apparatus according to claim 17, wherein the universal time comprises a year and a day of the year.

19. The apparatus according to claim 13, wherein at least one of said inner satellite, said at least one leading satellite, and said at least one trailing satellite is located at a Moon-Earth Lagrange point.

20. The apparatus according to claim 13, wherein each satellite of the plurality of satellites comprises about 180° of latitude and longitude coverage of the Earth.
